(19) United States
(12) Patent Application Publication
(10) Pub. No.: US 2026/0003155 A1
(43) Pub. Date: Jan. 1, 2026

(54) LENS MODULE AND IMAGING DEVICE

(71) Applicant: CANON KABUSHIKI KAISHA, Tokyo (JP)

(72) Inventor: SHOTA TANAKA, Chiba (JP)

(21) Appl. No.: 19/244,980

(22) Filed: Jun. 20, 2025

(30) Foreign Application Priority Data
Jun. 27, 2024 (JP) 2024-103746

(51) Int. Cl. G02B 7/02

(52) U.S. Cl. CPC G02B 7/022

(57) ABSTRACT

Provided is a lens module with a lens barrel for holding a lens and having a threaded portion on an outer peripheral surface; a lens holder for holding the lens barrel to be movable along an optical axis direction of the lens, the lens holder having a threaded portion on an inner peripheral surface, the threaded portion of the lens barrel and the threaded portion of the lens holder being screwed together; and a biasing member arranged between the outer peripheral surface of the lens barrel and the inner peripheral surface of the lens holder, with a protruding part formed on a part of the inner peripheral surface of the lens holder, and with the biasing member biasing the lens barrel toward the lens holder by contacting the protruding part.

### BACKGROUND

### Field

The present disclosure relates to a lens module and an imaging device including the lens module.

### Related Art

Screw-in lens modules can adjust focus by rotating a lens barrel holding a lens, thereby moving the lens barrel forward and backward in an optical axis direction. In a screw-in lens module, threaded portions are formed in the lens barrel and the lens holder to which the lens barrel is attached. The lens holder and the lens barrel are screwed together via the threaded portions, and when the lens barrel is rotated, the lens barrel moves relative to the lens holder in the optical axis direction.

In the screw-in lens module, backlash may occur between the threaded portion of the lens barrel and the threaded portion of the lens holder due to tolerances and manufacturing errors. If the backlash causes the lens barrel to incline with respect to the lens holder, there is a risk of the lens barrel inclining with respect to an imaging sensor. In particular, in the screw-in lens module, the lens barrel moves every time it is rotated to adjust the focus, so an inclination of the lens barrel changes. In a state where the inclination of the lens barrel changes, it takes time and effort to adjust the inclination of the imaging sensor in accordance with the inclination of the lens barrel.

Japanese Patent Application Laid-Open No. 2023-74047 discusses a technique by which a lens barrel has an extension portion that is a part of the lens barrel and that elastically deforms, and when the lens barrel and a lens holder are screwed together, the extension portion comes into contact with the lens holder and elastically deforms to generate a reaction force, with which backlash between the lens barrel and the lens holder is suppressed.

However, in Japanese Patent Application Laid-Open No. 2023-74047, one end of the lens barrel is biased toward the center of the optical axis by the reaction force of the elastic deformation of the lens barrel, and when the lens barrel is rotated, a position where the reaction force of the elastic deformation of the lens barrel is generated will change. Therefore, changes in the inclination of the lens barrel are not reduced when the lens barrel is rotated.

### SUMMARY

An aspect of the present disclosure provides a lens module that includes a lens barrel having a threaded portion on an outer peripheral surface thereof, the lens barrel configured to hold a lens; a lens holder having a threaded portion on an inner peripheral surface thereof, the threaded portion of the lens barrel and the threaded portion of the lens holder being screwed together, the lens holder configured to hold the lens barrel such that the lens barrel is movable along an optical axis direction of the lens; and a biasing member arranged between the outer peripheral surface of the lens barrel and the inner peripheral surface of the lens holder, with a protruding part formed on a part of the inner peripheral surface of the lens holder, and with the biasing member biasing the lens barrel toward the lens holder by contacting the protruding part.

Further features of the present disclosure will become apparent from the following description of exemplary embodiments with reference to the attached drawings.

### BRIEF DESCRIPTION OF THE DRAWINGS

FIG. 1 is an assembled perspective view of a camera module equipped with a lens module of a first exemplary embodiment.

FIG. 2 is an exploded perspective view of the camera module equipped with the lens module of the first exemplary embodiment.

FIG. 3 is a cross-sectional view of the lens module of the first exemplary embodiment.

FIG. 4 is a front view of a lens holder of the first exemplary embodiment.

FIG. 5 is a cross-sectional view of the lens module of the first exemplary embodiment taken along a plane on which a biasing member is arranged.

FIG. 6 is a partially enlarged view of a vicinity of a protruding part of the first exemplary embodiment.

FIG. 7 is a perspective view of the lens holder of the first exemplary embodiment.

FIG. 8 is a front view of a lens holder of a second exemplary embodiment.

FIG. 9 is a cross-sectional view of the lens module of the second exemplary embodiment taken along a plane on which a biasing member is arranged.

FIG. 10 is a partially enlarged view of a protruding part of the second exemplary embodiment.

FIG. 11 is a front view of the lens holder and an imaging unit of the second exemplary embodiment.

FIG. 12 is a cross-sectional view of a lens module of a third exemplary embodiment.

FIG. 13 is a cross-sectional view of the lens module of the third exemplary embodiment taken along a plane on which a biasing member is arranged.

FIG. 14 is a partially enlarged cross-sectional view of a protruding part of the third exemplary embodiment.

FIG. 15 is a cross-sectional view of the camera module of the first exemplary embodiment.

### DESCRIPTION OF THE EMBODIMENTS

Hereinafter, exemplary embodiments of the present disclosure will be described in detail with reference to the accompanying drawings.

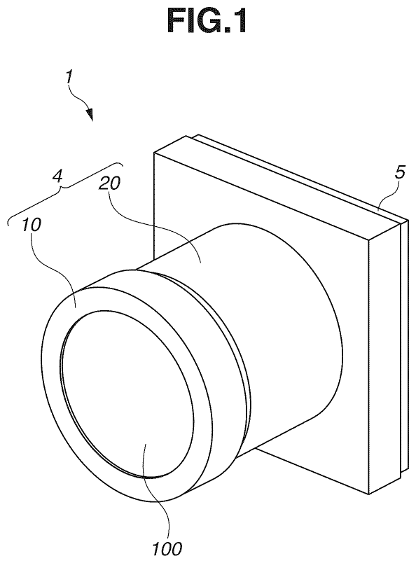

A lens module according to a first exemplary embodiment will be described with reference to FIGS. 1 to 7. FIG. 1 is an assembled perspective view of a camera module equipped with the lens module of the first exemplary embodiment.

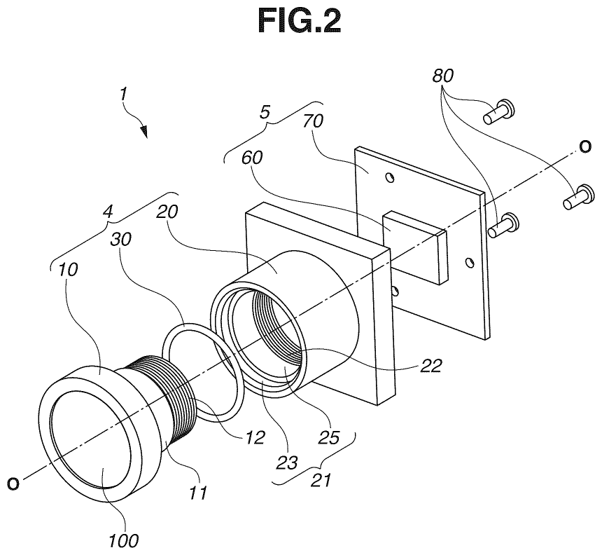

FIG. 2 is an exploded perspective view of the camera module equipped with the lens module of the first exemplary embodiment.

A camera module 1 includes a lens module 4 and an imaging unit 5 fixed to the lens module 4. The lens module 4 includes a lens barrel 10, a lens holder 20, and a biasing member 30. The lens barrel 10 holds a lens group 100 including at least one lens. The lens barrel 10 is detachably (replaceably) attached to the lens holder 20. Thus, when a focal length is to be changed, the lens barrel 10 is replaced. The lens holder 20 holds the lens barrel 10 such that the lens barrel 10 can move forward and backward, i.e. along, an optical axis O direction of the lens. The biasing member 30 biases the lens barrel 10. The biasing member 30 seals a gap between the lens holder 20 and the lens barrel 10.

The imaging unit 5 includes an imaging element 60 and an imaging substrate 70. The imaging element 60 is a complementary metal oxide semiconductor (CMOS) sensor or a charge-coupled device (CCD) sensor. The imaging element 60 photoelectrically converts an optical image (subject image) formed by an imaging optical system, and outputs an analog electric signal (imaging signal). The imaging element 60 is mounted on the imaging substrate 70. The imaging substrate 70 is fixed to the lens holder 20 with screws 80. The imaging substrate 70 and the lens holder 20 may be fixed by an adhesive. The imaging substrate 70 may be fixed to a plate member, and the imaging substrate 70 may be fixed to the lens holder 20 via the plate member. A sealing member that prevents attachment of dust to the imaging element 60 may be arranged between the imaging substrate 70 and the lens holder 20.

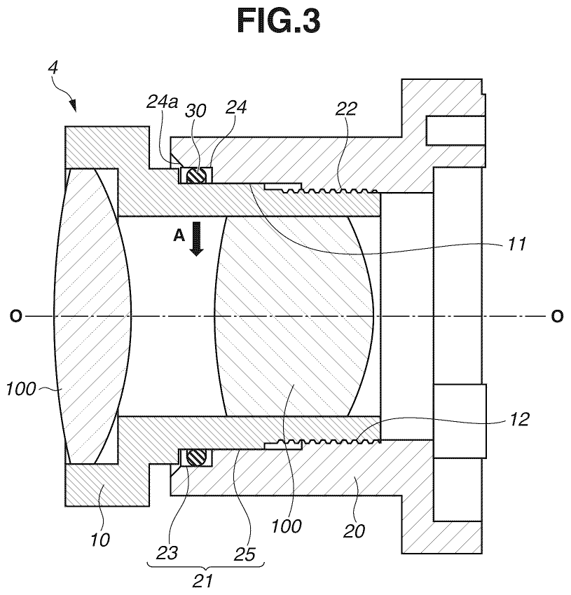

The lens module 4 is described in detail with reference to FIG. 3. FIG. 3 is a cross-sectional view of the lens module 4 of the first exemplary embodiment.

The lens barrel 10 has a cylindrical part 11 on an outer peripheral surface thereof. The cylindrical part 11 has a male threaded portion 12 formed at least along a part thereof. The lens barrel 10 is made of a metal such as aluminum or a resin such as polycarbonate.

The lens holder 20 has a cylindrical part 21 on an inner peripheral surface thereof. The cylindrical part 21 includes a first cylindrical part 25 and a second cylindrical part 23 (inner peripheral contact part). The first cylindrical part 25 has a female threaded portion 22 formed at least along a part thereof. The second cylindrical part 23 is a portion where the biasing member 30 is arranged and is in contact with the second cylindrical part 23. The second cylindrical part 23 is located on an object side relative to the first cylindrical part 25 along, i.e., in a direction of, an optical axis O.

The inner diameter of the second cylindrical part 23 is larger than the inner diameter of the first cylindrical part 25, providing the cylindrical part 21 with a stepped shape. The first cylindrical part 25 and the second cylindrical part 23 may extend along a same plane. The lens holder 20 may be formed of a metal, such as aluminum, or a resin, such as polycarbonate. The second cylindrical part 23 will be referred to as the inner peripheral contact part.

The biasing member 30 is an annular packing formed of an elastic material such as silicon. The biasing member 30 is sandwiched between the cylindrical part 11 of the lens barrel 10 and the inner peripheral contact part 23 of the lens holder 20. Since the biasing member 30 is sandwiched between the lens barrel 10 and the lens holder 20, the biasing member 30 seals the gap between the lens barrel 10 and the lens holder 20. In addition, the biasing member 30 contacts a protruding part 24 of the lens holder 20, described below, and biases the lens barrel 10 toward the lens holder 20. The biasing member 30 biases the lens barrel 10 in substantially the same direction as a direction in which the protruding part 24 protrudes.

As illustrated in FIG. 3, the biasing member 30 is arranged on the object side in the direction of, i.e. along, the optical axis O relative to the male threaded portion 12 of the lens barrel 10.

The lens barrel 10 is attached to the lens holder 20 by screwing the male threaded portion 12 of the lens barrel 10 into the female threaded portion 22 of the lens holder 20. When the lens barrel 10 is rotated with respect to the lens holder 20, the lens barrel 10 moves along, i.e., forward and backward, the direction of the optical axis O with respect to the lens holder 20. The focus can be adjusted by changing the position of the lens barrel 10 in the direction of the optical axis O with respect to the imaging unit 5 fixed to the lens holder 20. Due to tolerances and manufacturing errors, backlash may occur between the male threaded portion 12 of the lens barrel 10 and the female threaded portion 22 of the lens holder 20. In other words, a minute gap exists between the male threaded portion 12 of the lens barrel 10 and the female threaded portion 22 of the lens holder 20. This minute gap may cause the lens barrel 10 to incline with respect to the imaging element 60. After a position adjustment of the lens barrel 10 is completed, an inclination adjustment of the imaging element 60 is performed. The inclination adjustment is performed while the imaging substrate 70, on which the imaging element 60 is mounted, is inclined.

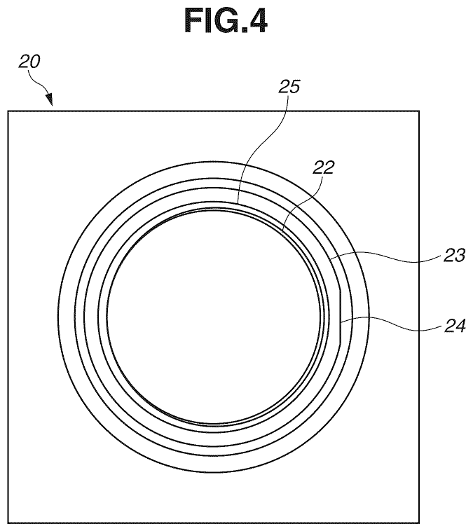

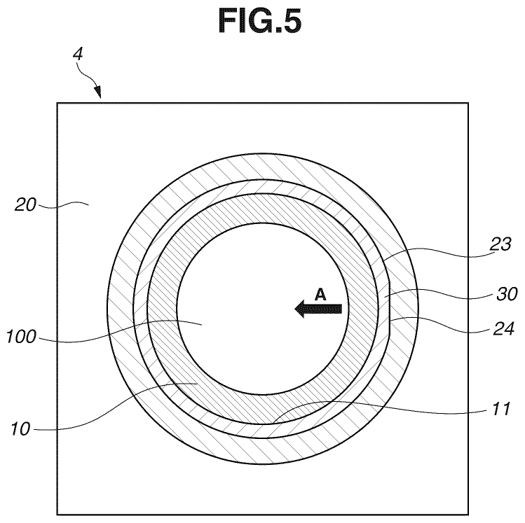

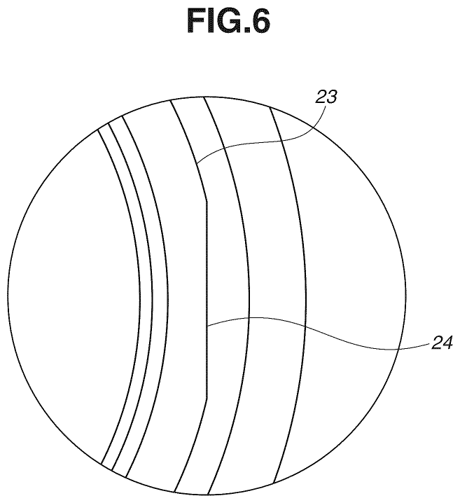

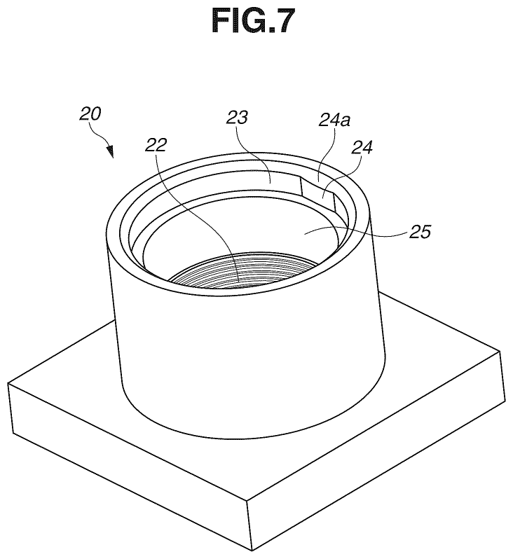

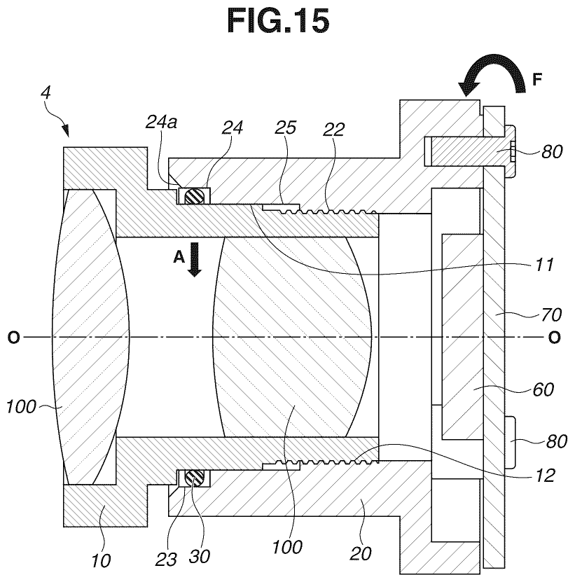

The inner peripheral contact part 23 of the lens holder 20 will be described in detail with reference from FIGS. 4 to 7. FIG. 4 is a front view of the lens holder 20 of the first exemplary embodiment. FIG. 5 is a cross-sectional view taken along a plane on which the biasing member 30 of the lens module of the first exemplary embodiment is arranged. FIG. 6 is a partially enlarged view of a vicinity of the protruding part 24 of the first exemplary embodiment. FIG. 7 is a perspective view of the lens holder 20 of the first exemplary embodiment. FIG. 15 is a cross-sectional view of the camera module 1 of the first exemplary embodiment.

The lens holder 20 has the protruding part 24 formed on the inner peripheral contact part 23. As illustrated in FIG. 7, the protruding part 24 protrudes from the inner peripheral contact part 23 in the direction orthogonal to the optical axis O. As illustrated in FIG. 6, the inner peripheral contact part 23 and the protruding part 24 are continuously connected along an inclined surface, i.e. without a step, along the inclined surface. The biasing member 30 contacts the protruding part 24 and biases the lens barrel 10 toward the lens holder 20.

As illustrated in FIGS. 3 and 7, a portion of the protruding part 24 has an inclined portion 24a that inclines inward (toward the optical axis O) as proximity to the imaging element 60 increases. In a state where the lens barrel 10 and the lens holder 20 are screwed together, the gap between the protruding part 24 and the cylindrical part 11 of the lens barrel 10 is smaller than the gap between the inner peripheral contact part 23 and the cylindrical part 11 of the lens barrel 10.

Accordingly, at a location where the protruding part 24 is provided, the protruding part 24 increases an amount of pressure applied to the biasing member 30, with the amount of pressure exceeding, i.e., being greater than, the amount of pressure at a location where the protruding part 24 is not provided. Thus, with the protruding part 24, the biasing member 30 exerts a biasing force on the lens barrel 10 that is greater than that in a case where the protruding part 24 is not provided. Accordingly, the lens barrel 10 is constantly biased with respect to the lens holder 20 in the direction of an arrow A, which is a direction orthogonal to the optical axis O. Thus, even when the lens barrel 10 is rotated for focus adjustment, inclination of the lens barrel 10 can be reduced.

Since changes in the inclination of the lens barrel 10 can be reduced, inclination of the imaging unit 5 can be easily adjusted according to a tendency of the inclination of the lens barrel 10. As described above, the lens barrel 10 is constantly biased in the direction of the arrow A, orthogonal to the optical axis O with respect to the lens holder 20. Accordingly, the lens barrel 10 tends to incline counterclockwise around an orthogonal direction orthogonal to the optical axis O. Therefore, as illustrated in FIG. 15, the imaging substrate 70 of the imaging unit 5 is rotated counterclockwise (in the direction of an arrow F) around the orthogonal direction orthogonal to the optical axis O, so that the imaging substrate 70 is adjusted to incline in the same direction as the inclination of the lens barrel 10. A method for adjusting and fixing the inclination of the imaging unit 5 may involve sandwiching a washer or the like between contact surfaces of the imaging substrate 70 and the lens holder 20 to adjust the inclination of the imaging unit 5, and fixing the imaging unit 5 with a screw, among other methods.

When the user rotates the lens barrel 10 to adjust the focus, since changes in the inclination of the lens barrel 10 are reduced, there is no need to adjust the inclination of the imaging unit 5 each time.

Since the changes in the inclination of the lens barrel 10 are reduced, adjustment of the inclination of the imaging unit 5 and fixing of the imaging unit 5 to the lens holder 20 may not be needed. Alternatively, a configuration may be employed in which the lens holder 20 may be shaped while the height of the contact surface of the lens holder 20 that comes into contact with the imaging unit 5 is corrected in accordance with the tendency of the inclination of the lens barrel 10, so that the inclination of the lens barrel 10 and the inclination of the imaging unit 5 can be matched without adjustment.

As described above, in the present exemplary embodiment, the lens barrel 10 is constantly biased with respect to the lens holder 20 in the direction orthogonal to the optical axis O, so that the changes in the inclination of the lens barrel 10 can be reduced compared to that in a configuration in which the lens barrel 10 is not biased in the direction orthogonal to the optical axis. Thus, adjustment of the inclination of the imaging unit 5 is simplified.

There is no need to form an opening in the lens holder 20 to provide a biasing member, a pressing member, a cover member, and the like, and changes in the inclination of the lens barrel 10 can be reduced by sandwiching the biasing member 30 between the lens barrel 10 and the lens holder 20.

In the present exemplary embodiment, the biasing member 30 is sandwiched between the lens barrel 10 and the lens holder 20 to seal the gap between the lens barrel 10 and the lens holder 20. Accordingly, the biasing member 30 not only reduces the changes in the inclination of the lens barrel 10, but also functions to suppress intrusion of water, dust, and the like into the lens holder 20.

Sandwiching the biasing member 30 between the lens barrel 10 and the lens holder 20 prevents the intrusion of water, dust, and the like into the lens holder 20, without adding an additional part to reduce the changes in the inclination of the lens barrel 10. This makes it possible to reduce the changes in the inclination of the lens barrel 10 with a simple configuration. The biasing member 30 may prevent the intrusion of water, dust, and the like.

In the present exemplary embodiment, the inner peripheral contact part 23 and the protruding part 24 are continuously connected along the inclined surface, i.e., without a step. This allows improved following and contact by the biasing member 30, even in the vicinity of the boundary between the inner peripheral contact part 23 and the protruding part 24, to reduce formation of a gap therebetween. Accordingly, the biasing member 30 suppresses the intrusion of water and dust into the lens holder 20 The inner peripheral contact part 23 and the protruding part 24 may be continuously connected.

In the present exemplary embodiment, the biasing member 30 is arranged on the object side in the direction of the optical axis O relative to the male threaded portion 12 of the lens barrel 10. This suppresses the intrusion of dust and the like into the male threaded portion 12 of the lens barrel 10 and the female threaded portion 22 of the lens holder 20, and protects the male threaded portion 12 and the female threaded portion 22 from dust and the like that may hinder rotation of the lens barrel 10. In addition, in a case where the lens barrel 10 or the lens holder 20 is made of metal, it is possible to prevent water and the like from reaching the male threaded portion 12 of the lens barrel 10 or the female threaded portion 22 of the lens holder 20, and prevent rusting of the male threaded portion 12 or the female threaded portion 22. The biasing member 30 may be arranged on the object side along the optical axis O relative to the male threaded portion 12 of the lens barrel 10.

In the present exemplary embodiment, a portion of the protruding part 24 has the inclined portion 24a that inclines with respect to the optical axis O as illustrated in FIGS. 3 and 7. Accordingly, the biasing member 30 is less likely to be caught on the protruding part 24 when the biasing member 30 is sandwiched while the lens barrel 10 and the lens holder 20 are screwed together during assembly. Thus, assembly of the biasing member 30 in a correct assembly position where it contacts the inner peripheral contact part 23 and the protruding part 24 is simplified. The portion of the protruding part 24 may not include the inclined portion 24a.

As described above, according to the present exemplary embodiment, in a screw-in lens module, it is possible to reduce changes in the inclination of the lens barrel with a simple configuration.

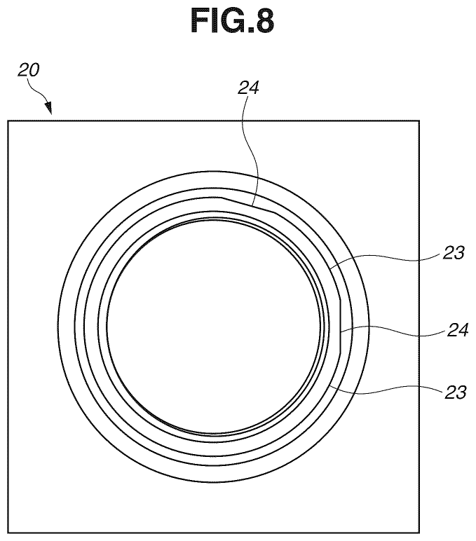

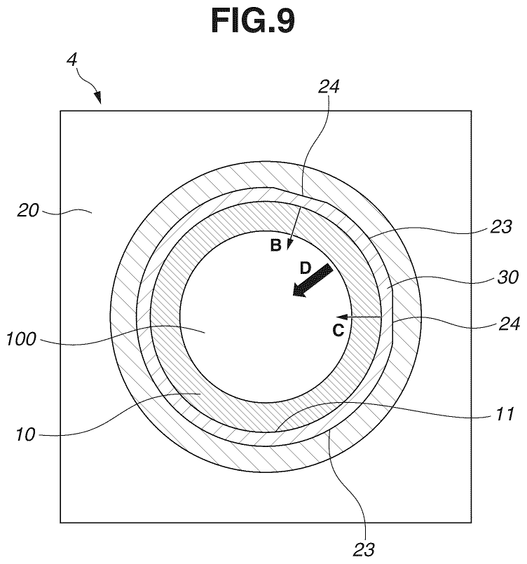

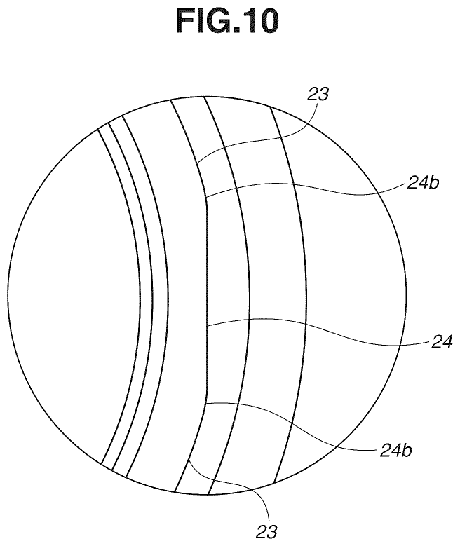

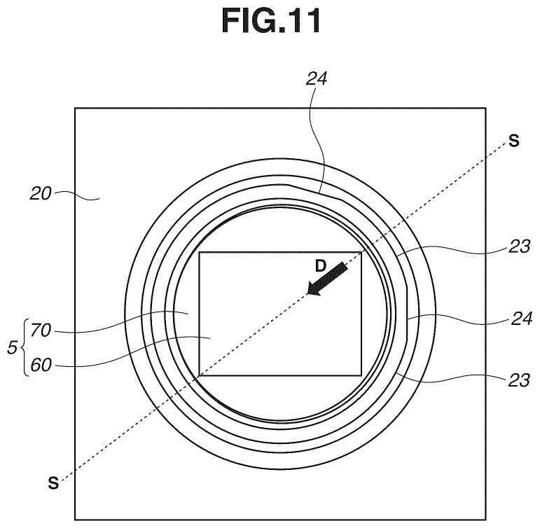

A lens module according to a second exemplary embodiment will be described with reference to FIGS. 8 to 11. In the present exemplary embodiment, components in common with the first exemplary embodiment are given the same reference numerals as those in the first exemplary embodiment. Descriptions of configurations in common with the first exemplary embodiment are incorporated by reference without being repeated, for conciseness. FIG. 8 is a front view of a lens holder of the second exemplary embodiment. FIG. 9 is a cross-sectional view of the lens module of the second exemplary embodiment taken along a plane on which a biasing member is arranged. FIG. 10 is a partially enlarged view of a protruding part of the second exemplary embodiment. FIG. 11 is a front view of the lens holder and an imaging unit of the second exemplary embodiment.

The inner peripheral contact part 23 of the lens holder 20 is provided with two protruding parts 24. In a state where the lens barrel 10 and the lens holder 20 are screwed together, a gap between each of the protruding parts 24 of the lens holder 20 and the cylindrical part 11 is smaller than a gap between the inner peripheral contact part 23 and the cylindrical part 11. Accordingly, due to the protruding parts 24, at each location where the protruding part 24 is provided, the amount of pressure applied to the biasing member 30 exceeds, i.e., is greater than, the amount of pressure at a location where the protruding part 24 is not provided. As a result, a biasing force that the lens barrel 10 receives from the biasing member 30 is increased. Accordingly, the lens barrel 10 is constantly biased with respect to the lens holder 20 in a direction of an arrow D, which is a direction orthogonal to the optical axis O and is a direction of a resultant force of biasing forces B and C generated at the locations where the protruding parts 24 are provided.

As illustrated in FIG. 11, the two protruding parts 24 are provided such that the direction of the arrow D in which the lens barrel 10 is biased is parallel to a straight line S connecting diagonal corners of the imaging element 60. The term “parallel” includes perfect parallelism and substantial parallelism within an error range, e.g. an error range of manufacturing tolerances.

As illustrated in FIG. 10, connecting portions 24b each have a fillet or similar shape, with connecting portions 24b provided between the inner peripheral contact part 23 and the protruding part 24. The protruding part 24 and the inner peripheral contact part 23 are continuously connected via the connecting portions 24b. The connecting portions 24b allows improved following and contact by the biasing member 30, even in the vicinity of the boundary between the inner peripheral contact part 23 and the protruding parts 24. Accordingly, a gap is unlikely to be formed, and the biasing member 30 provides improved prevention of intrusion of water and dust into the lens holder 20. Note that the connecting portions 24b may not be provided. In an embodiment, the inner peripheral contact part 23 and the protruding parts 24 may not be continuously connected.

As described above, in the present exemplary embodiment, the two protruding parts 24 are provided in the inner peripheral contact part 23 of the lens holder 20. Accordingly, even when the lens barrel 10 is rotated for focus adjustment, the lens barrel 10 is constantly biased with respect to the lens holder 20 in the direction of the arrow D orthogonal to the optical axis O, so that changes in the inclination of the lens barrel 10 can be reduced.

There is no need to form an opening in the lens holder 20 to provide a biasing member, a pressing member, a cover member, and the like, and the changes in the inclination of the lens barrel 10 can be reduced with a simple configuration in which the biasing member 30 is sandwiched between the lens barrel 10 and the lens holder 20.

In the present exemplary embodiment, the number of locations at which the lens barrel 10 is biased by pressing of the biasing member 30 by the protruding parts 24 and the number of locations at which the lens barrel 10 contacts the lens holder 20 due to the biasing are three in total, to reduce changes in the inclination of the lens barrel 10.

The two protruding parts 24 may be provided within a half circumference region of the inner peripheral contact part 23. In other words, spacing between the two protruding parts 24 may be within 180 degrees in a circle centered on the optical axis.

Accordingly, a force by which the biasing forces B and C cancel each other out in the resultant force of the biasing forces B and C becomes smaller, making it easier to stably bias the lens barrel 10 toward the lens holder 20 in the direction of the arrow D orthogonal to the optical axis O.

The number of protruding parts 24 may be two, three, or more. Alternatively, a single protruding part 24 may be provided, as in the first exemplary embodiment.

The two protruding parts 24 are provided such that the direction of the arrow D in which the lens barrel 10 is biased is parallel to the straight line S connecting the diagonal corners of the imaging element 60. This makes it easier to reduce changes in the inclination of the lens barrel 10. The diagonal corners of the imaging element 60 are the furthest from the optical axis and are therefore susceptible to an influence of the inclination.

Making the direction of the arrow D in which the lens barrel 10 is biased parallel to the straight line S connecting the diagonal corners of the imaging element 60 reduces a decrease in peripheral resolution in the image. The lens barrel 10 may be biased in a direction other than the diagonal direction of the imaging element 60.

As described above, according to the present exemplary embodiment, in a screw-in lens module, it is possible to reduce changes in the inclination of the lens barrel with a simple configuration.

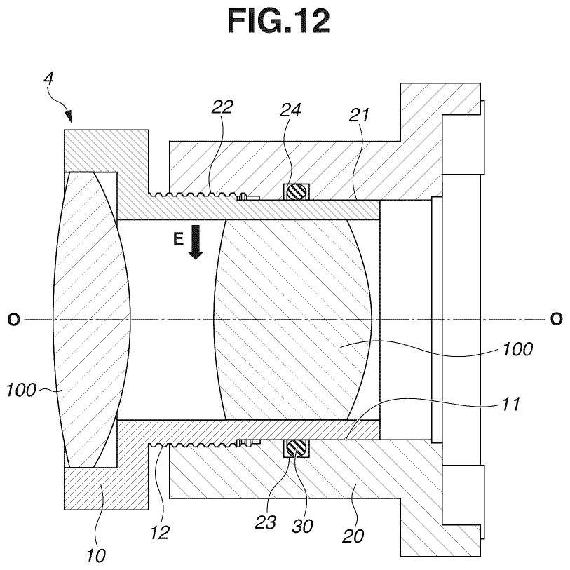

A lens module according to a third exemplary embodiment will be described with reference to FIGS. 12 to 14. In the present exemplary embodiment, components in common with the first exemplary embodiment are given the same reference numerals as those in the first exemplary embodiment and description of configurations in common with the first exemplary embodiment are incorporated by reference without being repeated, for conciseness.

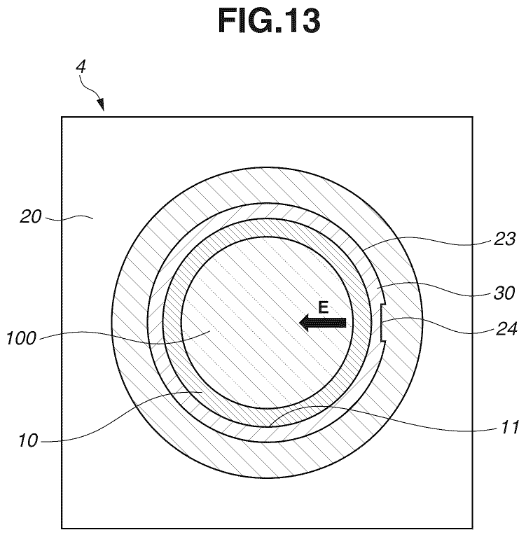

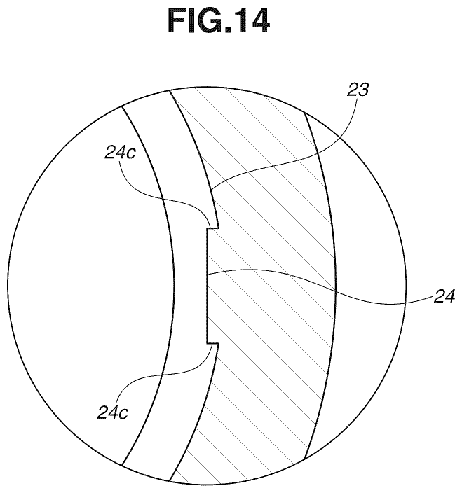

FIG. 12 is a cross-sectional view of the lens module of the third exemplary embodiment. FIG. 13 is a cross-sectional view of the lens module of the third exemplary embodiment taken along a plane on which a biasing member is arranged. FIG. 14 is a partially enlarged cross-sectional view of a protruding part of the third exemplary embodiment.

In the third exemplary embodiment, a biasing member 30 is arranged on an imaging element 60 side in the direction of the optical axis O relative to the male threaded portion 12 of the lens barrel 10. The biasing member 30 is sandwiched between the lens barrel 10 and a lens holder 20. The biasing member 30 seals the gap between the lens barrel 10 and the lens holder 20. Accordingly, the biasing member 30 prevents the intrusion of water, dust, and the like into the lens holder 20. The biasing member 30 may prevent the intrusion of water, dust, and the like.

As illustrated in FIG. 14, side surface portions 24c are provided between the inner peripheral contact part 23 and the protruding part 24. For the biasing member 30 to prevent the intrusion of water, dust, and the like, the length of the side surface portions 24c may be as short as possible, to provide improved following and contact by the biasing member 30, even in the vicinities of the side surface portions 24c.

The side surface portions 24c may not be provided, and the inner peripheral contact part 23 and the protruding part 24 may be continuously connected as in the first exemplary embodiment. Alternatively, the inner peripheral contact part 23 and the protruding part 24 may be continuously connected via connecting portions 24b, as in the second exemplary embodiment. A plurality of protruding parts 24 may be formed as in the second exemplary embodiment. A portion of the protruding part 24 may have an inclined portion 24a that inclines with respect to the optical axis O as in the first exemplary embodiment.

In a state where the lens barrel 10 and the lens holder 20 are screwed together, the gap between the protruding part 24 and a cylindrical part 11 is smaller than the gap between the inner peripheral contact part 23 and the cylindrical part 11. Accordingly, at the location where the protruding part 24 is provided, the amount of pressure applied to the biasing member 30 increases, and the biasing force that the lens barrel 10 receives from the biasing member 30 increases. Accordingly, the lens barrel 10 is constantly biased with respect to the lens holder 20 in the direction of an arrow E, which is a direction orthogonal to the optical axis O.

Even when the lens barrel 10 is rotated for focus adjustment, the lens barrel 10 is constantly biased with respect to the lens holder 20 in the direction of the arrow E orthogonal to the optical axis O, so that the changes in the inclination of the lens barrel 10 can be reduced.

There is no need to form an opening in the lens holder 20 to provide a biasing member, a pressing member, a cover member, and the like, and the changes in the inclination of the lens barrel 10 can be reduced with a simple configuration in which the biasing member 30 is sandwiched between the lens barrel 10 and the lens holder 20.

As described above, according to the present exemplary embodiment, in a screw-in lens module, it is possible to reduce changes in the inclination of the lens barrel with a simple configuration.

### Modification

In the first to third exemplary embodiments, a plurality of annular biasing members 30 may be provided. In a configuration using the plurality of biasing members 30, the inner peripheral contact part 23 of the lens holder 20 with which at least one of the biasing members 30 comes into contact has the protruding part 24.

While the exemplary embodiments of the present disclosure have been described above, the present disclosure is not limited to these exemplary embodiments, and various modifications and changes can be made within the scope of the gist of the present invention. The present disclosure is not limited to specific configurations, to the extent that a configuration takes into consideration a design and function.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-103746, filed Jun. 27, 2024, the entirety of which is incorporated herein by reference.

What is claimed is:

1. A lens module comprising:
a lens barrel having a threaded portion on an outer peripheral surface thereof, the lens barrel configured to hold a lens;
a lens holder having a threaded portion on an inner peripheral surface thereof, the threaded portion of the lens barrel and the threaded portion of the lens holder being screwed together, the lens holder configured to hold the lens barrel such that the lens barrel is movable along an optical axis direction of the lens; and
a biasing member arranged between the outer peripheral surface of the lens barrel and the inner peripheral surface of the lens holder,
wherein a protruding part is formed on a part of the inner peripheral surface of the lens holder, and
wherein the biasing member is configured to bias the lens barrel toward the lens holder by contacting the protruding part.

2. The lens module according to claim 1, wherein the biasing member biases the lens barrel in a direction that is the same or substantially the same as a direction in which the protruding part protrudes.

3. The lens module according to claim 1, wherein the protruding part is an inclined surface extending from the inner peripheral surface of the lens holder.

4. The lens module according to claim 1, wherein the protruding part is provided on an object side in the optical axis direction relative to the threaded portion of the lens holder.

5. The lens module according to claim 1, wherein an inner diameter of the inner peripheral surface of the lens holder at a position along the optical axis where the protruding part is provided is larger than an inner diameter of a position along the optical axis where the threaded portion is provided.

6. The lens module according to claim 1,
wherein the protruding part has a portion that inclines toward the optical axis, and
wherein the incline of the portion increases with proximity to an imaging element in the optical axis direction.

7. The lens module according to claim 1, wherein the lens holder is provided with a plurality of protruding parts.

8. The lens module according to claim 7, wherein each protruding part of the plurality of protruding parts is arranged within 180 degrees in a circle centered on the optical axis of the lens.

9. The lens module according to claim 1, wherein the biasing member is configured to bias the lens barrel in a direction diagonal to the optical axis direction.

10. The lens module according to claim 1, wherein the biasing member is configured to seal a gap between the outer peripheral surface of the lens barrel and the inner peripheral surface of the lens holder.

11. An imaging device comprising:
an imaging element; and
the lens module according to claim 1.

12. A lens module comprising:
a lens barrel configured to hold a lens;
a lens holder provided between the lens barrel and an imaging element affixed to the lens holder, the lens holder configured to permit movement of the lens barrel along an optical axis direction of the lens; and
a biasing member arranged between a surface of the lens barrel and a surface of the lens holder, and configured to reduce an incline of the lens barrel relative to the imaging element.

13. The lens module of claim 12, wherein the incline is caused by backlash between the lens barrel and the lens holder.

14. The lens module of claim 13, wherein the backlash is caused by a threaded portion of the lens barrel contacting a threaded portion of the lens holder.

15. The lens module of claim 14,
wherein the threaded portion of the lens barrel is a male threaded portion provided on an outer surface of the lens barrel,
wherein the threaded portion of the lens holder is a female threaded portion provided on an inner surface of the lens holder, and
wherein the threaded portion of the lens barrel and the threaded portion of the lens holder are configured to screw together.

16. The lens module of claim 12, further comprising a protruding part formed on a part of the surface of the lens holder.

17. The lens module of claim 16, wherein the biasing member is configured to bias the lens barrel toward the lens holder by contacting the protruding part.
